(19) United States
(12) Patent Application Publication
(10) Pub. No.: US 2013/0198417 A1
(43) Pub. Date: Aug. 1, 2013

(54) ELECTRONIC APPARATUS

(71) Applicant: PANASONIC CORPORATION, Osaka (JP)

(72) Inventor: TORU TAKASHIMA, Osaka (JP)

(73) Assignee: PANASONIC CORPORATION, Osaka (JP)

(21) Appl. No.: 13/747,576

(22) Filed: Jan. 23, 2013

(30) Foreign Application Priority Data
Jan. 27, 2012 (JP) 2012-015187

(51) Int. Cl. G06F 9/44

(52) U.S. Cl. CPC G06F 9/4411
USPC 710/8

(57) ABSTRACT

An electronic apparatus capable of operating as an USB function when being connected to a host device via an USB interface is provided. The electronic apparatus includes a storing unit configured to store a descriptor which is information indicating a function of the electronic apparatus, a sending unit configured to send the descriptor to the host device, a detector configured to detect a suspend signal that is output from the host device and indicates suspension, and a controller configured to perform predetermined processing based on the detection result, when the detector detects the suspend signal after the sending unit sends the descriptor to the host device, in enumeration between the electronic apparatus and the host device.

### BACKGROUND

1. Technical Field

The present disclosure relates to an electronic apparatus capable of connecting to external apparatus via a USB (Universal Serial Bus) interface.

2. Related Art

USB devices are known as an electronic apparatus capable of connecting to an external apparatus via an USB (Universal Serial Bus) interface. Also, USE devices with a plurality of functions are known. The USB device with a plurality of functions stores a plurality of USB descriptors (hereinafter, referred to as “descriptors”) as information indicating the respective functions.

Various approaches to establish communication between such an USB device and a host device have been proposed. For example, JP2005-78304A discloses an USB function device (USB device) as described below. Upon connected to a host device, the USB function device is requested for a descriptor by the host device. In response to the request, the USE function device sends to the host device a descriptor indicating one function pre-selected by a user out of a plurality of functions. When the host device does not support the function indicated by the sent descriptor, after lapse of a certain time period, the USB function device selects another descriptor. Here, the second descriptor indicates a function different from the function indicated by the previously sent first descriptor. Then, the USB function device starts a USB bus reset for initializing the communication between the USB function device and the host device. When reconnected to the host device after the USB bus reset, the USB function device sends the selected second descriptor to the host device in response to the request from the host device for a descriptor.

That configuration improves the USB function device described in JP2005-78304A in the capability of establishing connection with the host device.

### SUMMARY

The conventional USB function device described in JP2005-78304A is inconvenient in that the conventional USB function device may take time for the processing of establishing the communication with the host device (i.e., enumeration). The problem is caused by such a reason described below.

Even when the USB function device sends a descriptor to the host device, the communication between the host device and the USB function device is not started unless the host device supports the function indicated by the descriptor. In order to avoid the situation in which the communication does not start at all, when the USB function device does not receive a response from the host device within a predetermined time period after sending the descriptor (i.e., in case of time out), the USB function device determines that the host device does not support the function indicated by the sent descriptor. In that case, the USB function device switches the function currently set in the USB function device to another function, and then starts an USB bus reset. Next, after the reconnection, the USB function device sends the descriptor corresponding to the new function to the host device. Such operations prevent the USB function device from starting the reconnection with the switched function for a certain time period when the USB function device sent a descriptor indicating a function which is not supported by the host device. That is the reason for taking time for the enumeration between the USB function device and the host device.

The present disclosure provides an electronic apparatus capable of performing enumeration-related processing at high speed when the electronic apparatus is connected to the host device.

A personal computer (PC) is known as a host device with a function for controlling an USB device. When such a PC is connected with an USB device, the PC requests a descriptor from the USB device. In response to the request, the USB device sends to the PC a descriptor indicating a function pre-selected by a user. The response performed by the PC to the sent descriptor differs depending on an operating system (OS) which is a software program for controlling the PC.

There is a PC (or an OS controlling the PC) that sends to the USE device a signal indicating suspension immediately after the PC (OS) determines that the PC does not support the descriptor sent to the PC.

Also when a conventional USB device is connected to a PC controlled by the above described OS via an USB interface, as already explained, the conventional USB devices are problematic in that they may take extra time in the enumeration

A first electronic apparatus according to the present disclosure is capable of operating as an USB function with being connected to a host device via an USB interface. The electronic apparatus includes a storing unit configured to store a descriptor which is information indicating a function of the electronic apparatus; a sending unit configured to send the descriptor to the host device; a detector configured to detect a suspend signal which is output from the host device and indicates suspension; and a controller configured to perform predetermined processing based on the detection result, when the detector detects the suspend signal after the sending unit sends the descriptor to the host device, in enumeration between the electronic apparatus and the host device.

A second electronic apparatus according to the present disclosure is capable of connecting to the host device. The host device sends a predetermined signal to the electronic apparatus when the host device does not support the function of the electronic apparatus. The electronic apparatus includes a storing unit configured to store function information as information indicating a function of the electronic apparatus; a sending unit configured to send the function information to the host device; a detector configured to detect a predetermined signal; and a controller configured to perform predetermined processing based on the detection result, when the detector detects the predetermined signal after the function information is sent to the host device, in processing for establishing communication between the electronic apparatus and the host device.

A third electronic apparatus according to the present disclosure is capable of operating as a USB device when connected to a host device via an USB interface. The said electronic apparatus comprises a storing unit configured to store a plurality of descriptors indicating a plurality of functions, respectively, a sending unit configured to send a first descriptor among the plurality of the descriptors to the host device, a detector configured to detect a suspend signal output from the host device, and a controller configured to instruct the sending unit to send another one of the plurality of descriptors to the host device when the detector detects the suspend signal after the sending unit sends the first descriptor to the host device.

The electronic apparatus according to the present disclosure performs, when the detector detects a suspend signal after a descriptor is sent to the host device via the sending unit, predetermined processing based on the detection result. Thereby, when connected to the host device, the electronic apparatus can perform enumeration-related processing faster than an electronic apparatus that detects time out.

### BRIEF DESCRIPTION OF THE DRAWINGS

FIG. 1 is a diagram for describing a part of a configuration of a digital camera according to the present embodiment and connection between the digital camera and a personal computer;

FIG. 2 is a block diagram illustrating an electric configuration of the digital camera according to the present embodiment;

FIG. 3A is a sequence chart for describing a general operation for establishing communication between a digital camera and a personal computer via an USB interface;

FIG. 3B is a sequence chart for describing an operation for establishing communication between the digital camera according to the present embodiment and a personal computer via an USB interface;

FIG. 4 is a diagram for describing a state transition of the digital camera according to the present embodiment during enumeration;

FIG. 5A is a first flowchart for describing a sequence of operations for the digital camera according to the present embodiment to establish connection with a personal computer via an USB interface (enumeration); and

FIG. 5B is a second flowchart for describing a sequence of operations for the digital camera according to the present embodiment to establish connection with a personal computer via an USB interface (enumeration).

### DETAILED DESCRIPTION OF THE PREFERRED EMBODIMENTS

An embodiment will be described below with reference to the attached drawings. Hereinafter, the host device will be exemplified by a personal computer and the electronic apparatus will be exemplified by a digital camera capable of connecting to the personal computer via an USB interface.

In the description of the present disclosure, certain unnecessary portions regarding, for example, conventional technology, redundant description on substantially the same configuration may be omitted for ease of description.

The following description and the attached drawings are disclosed to enable those skilled in the art to sufficiently understand the present disclosure, and are not intended to limit the subject matter of the claims.

### 1. Configuration of Digital Camera

A digital camera according to the present embodiment will be described.

### 1-1. Configuration on Exterior of Digital Camera

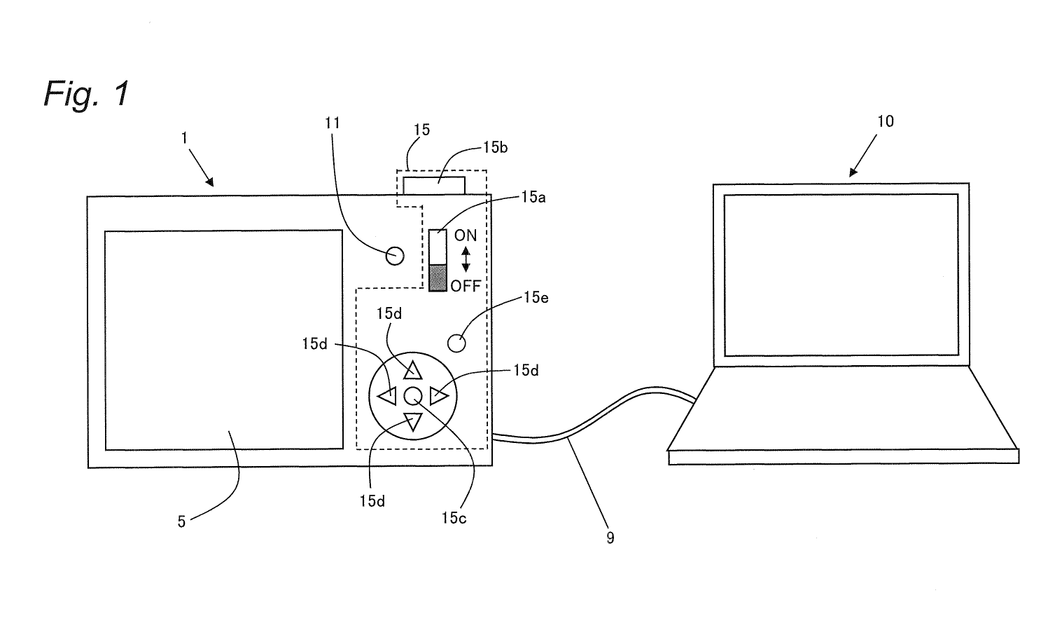

FIG. 1 is a diagram illustrating the digital camera according to the present embodiment and a personal computer connected to the digital camera. The digital camera 1 can be connected with the personal computer (hereafter, referred to as “PC”) 10 serving as an external apparatus via an USB cable 9. In this USB connection, the PC 10 is a host (USB host device) and the digital camera 1 is a function (peripheral, USE device).

The digital camera 1 has a liquid crystal monitor 5, an LED 11, and an operation unit 15. The operation unit 15 includes a power switch 15a, a shutter button 15b, a decision button 15c, a cursor key 15d, and a menu button 15e.

The liquid crystal monitor 5 is a display means for displaying a captured image or a through image. The operation unit 15 receives user's operations. The power switch 15a is a switch for switching ON/OFF the power of the digital camera 1 and slidable in the directions of the double arrow in the present drawing. When the power switch 15a is slid to the ON side of the double arrow, the power is switched ON. When the power switch 15a is slid to the OFF side of the double arrow, the power is switched OFF. The shutter button 15b is a button for operating the shutter of the digital camera 1. When the shutter button 15b is pressed down, the shutter operates. The cursor key 15d is a key for moving a cursor in the image displayed on the liquid crystal monitor 5. The decision button 15c is a button for performing operations including confirmation of an item selected with the cursor. The menu button 15e is a button for displaying a setting menu or the like in the image displayed on the liquid crystal monitor 5.

Note that the digital camera 1 may have, for example, an organic EL display panel in place of the liquid crystal monitor 5. Further, instead of these displaying members, the digital camera 1 may have any arbitrary device that can display images.

The LED 11 lights to signal the user that the battery is being charged. For this purpose, the LED 11 lights while the battery of the digital camera 1 is being charged with a voltage of 5V supplied from the PC 10 when the PC 10 and the digital camera 1 are connected via the USB cable 9.

### 1-2. Internal Configuration of Digital Camera

The configuration of the digital camera 1 will be described.

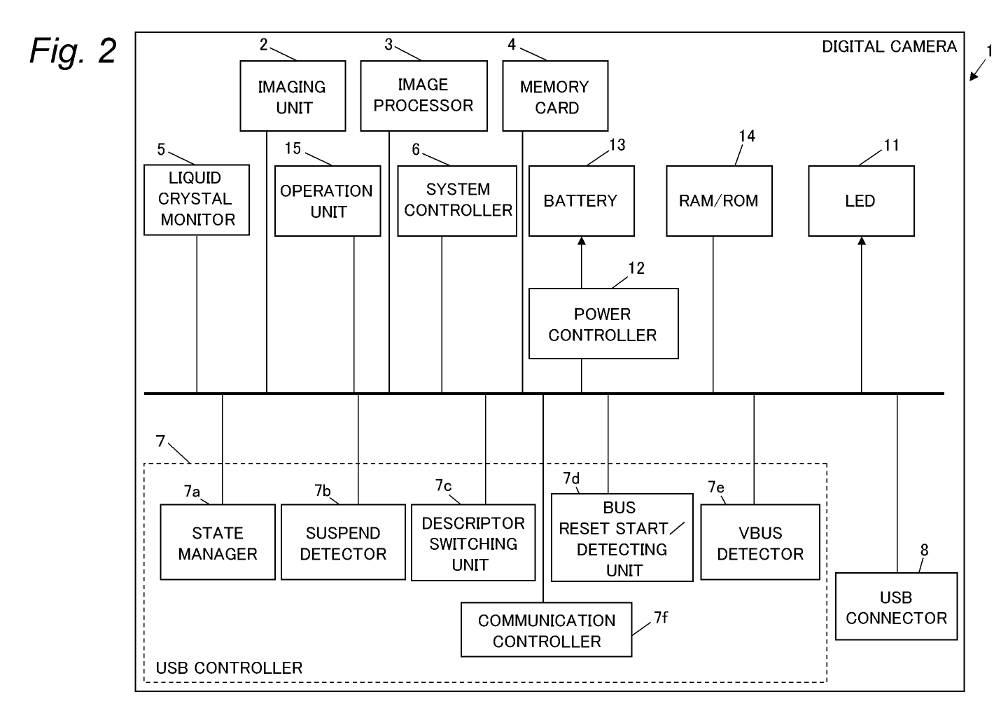

FIG. 2 is a block diagram illustrating an electric configuration of the digital camera 1. The digital camera 1 has an imaging unit 2, an image processor 3, a memory card 4, a system controller 6, an USB controller 7, an USB connector 8, a power controller 12, a battery 13, and a RAM/ROM 14.

The imaging unit 2 converts optical signals from the subject into electric signals to generate image data. The imaging unit 2 includes lenses, a CCD, and the like.

The image processor 3 performs predetermined processing on the image data generated by the imaging unit 2. For example, the image processor 3 performs enlarge processing, reduction processing, compression processing (JPEG compression and the like), and/or decompression processing on the image data. The image processor 3 outputs the processed image data to the liquid crystal monitor 5, the memory card 4, and/or the system controller 6.

The memory card 4 stores the image data output from the image processor 3. Also, the memory card 4 outputs the stored image data to the image processor 3. The memory card 4 includes a semiconductor memory (flash memory, ferro-electric memory, and so on) or the like.

The system controller 6 is a control unit for controlling the respective units of the digital camera 1 and includes a CPU or the like. The system controller 6 controls the imaging unit 2, the image processor 3, and the USB controller 7 based on operations received by the operation unit 15.

The USB connector 8 is a connector for connecting a USE cable 9.

The USB controller 7 is a means for controlling communication compliant with an USB standard. The USE controller 7 includes a state manager 7a, a suspend detector 7b, a descriptor switching unit 7c, a bus reset start/detecting unit 7d, a VBUS detector 7e, and a communication controller 7f.

The state manager 7a manages the state of the digital camera 1 in USB connection. The suspend detector 7b detects suspension (suspend state) of the PC 10. The descriptor switching unit 7c decides a device descriptor (described later) to be sent by the digital camera 1 to the PC 10 when the digital camera 1 receives a device descriptor request issued by the PC 10. The bus reset start/detecting unit 7d performs a control for resetting (bus reset) the communication via an USB between the digital camera 1 and the PC 10 on the digital camera 1 side. When the digital camera 1 is connected to the PC 10 via the USB cable 9, the VBUS detector 7e detects a voltage of 5V (hereinafter, referred to as “VBUS”) supplied from the PC 10 through a VBUS signal wire of the USB cable 9. By detecting the VBUS, the VBUS detector 7e detects the connection via the USB connector 8 between the digital camera 1 and the PC 10. The communication controller 7f controls the communication between the PC 10 and the digital camera 1.

The power controller 12 detects the power supply voltage of the battery 13 and/or the AC power and controls the battery 13 and/or the AC power to supply power needed to the operation of the digital camera 1 to the respective units of the digital camera 1.

When the PC 10 and the digital camera 1 are connected each other via the USB cable 9, the power controller 12 also controls charging of the battery 13 by the 5V power supply of the PC 10.

The RAM/ROM 14 includes a volatile RAM and a nonvolatile ROM which is dedicated to reading. The RAM temporarily stores the image data and the other data to be treated in the digital camera 1. The ROM stores predetermined unchangeable information, programs, and the like to be executed by the system controller 6. The ROM also stores device descriptors and configuration descriptors to be used by the USB controller 7 in the USB connection.

The device descriptors and the configuration descriptors according to the present embodiment are information in the form compliant with the USB standard.

The RAM/ROM 14 of the digital camera 1 according to the present embodiment stores two device descriptors and two configuration descriptors. Each of the device descriptors contains information indicating the device ID corresponding to the digital camera 1 and the number of supported communication configurations. Each of the device descriptors according to the present embodiment supports a single communication configuration. Hence, the device descriptors are associated with the configuration descriptors, respectively. The configuration descriptor includes at least the information item indicating the presence or absence of power request issued toward the PC 10 and the communication class (for example, mass storage class, audio class, and so on) supported by the digital camera 1. When including the information indicating that power is requested from the host device, the configuration descriptor also includes information indicating the power capacity to be requested.

The two configuration descriptors stored in the RAM/ROM 14 of the digital camera 1 will be described. Hereinafter, the two configuration descriptors will be referred to as “configuration descriptor A” and “configuration descriptor B”. The configuration descriptor A includes information indicating that the digital camera 1 requests power from the host device (PC 10 in the present embodiment) to operate on the bus power. Hereinafter, the information indicating that power is requested from the host device will be referred to as “information requesting power”.

The configuration descriptor B includes information indicating that the digital camera 1 does not request power from the PC 10 to cause the digital camera 1 to operates on the self-power. Hereinafter, the information indicating that power is not requested from the PC 10 will be referred to as “information requesting no power”.

Further, the configuration descriptor A also includes information indicating the value of power (e.g., 500 mA) to be requested from the PC 10 and information indicating that the communication class is the mass storage class. The configuration descriptor B also includes information indicating that the communication class supported by the digital camera 1 is the mass storage class.

Note that the digital camera 1 is an example of the electronic apparatus described in the SUMMARY. The RAM/ROM 14 is an example of the storing unit. The USB connector 8 is an example of the sending unit. The suspend detector 7b is an example of the detector. The USB controller 7 is an example of the controller.

### 2. Operation of Digital Camera

The operation performed by the digital camera 1 with the above described configuration to establish communication with the PC 10 upon connecting to the PC 10 will be described. First, a usual operation to establish communication in an USB connection will be described, and then, the operation performed by the digital camera 1 according to the present embodiment to establish communication with the PC 10 will be described.

### 2-1. Operation to Establish USB Connection

A usual operation to establish communication in an USE connection will be described.

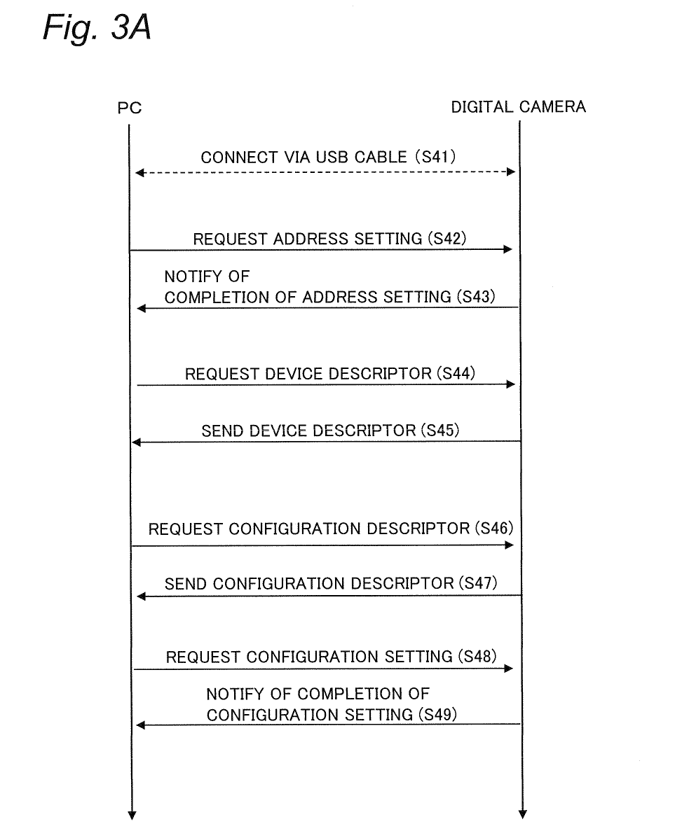

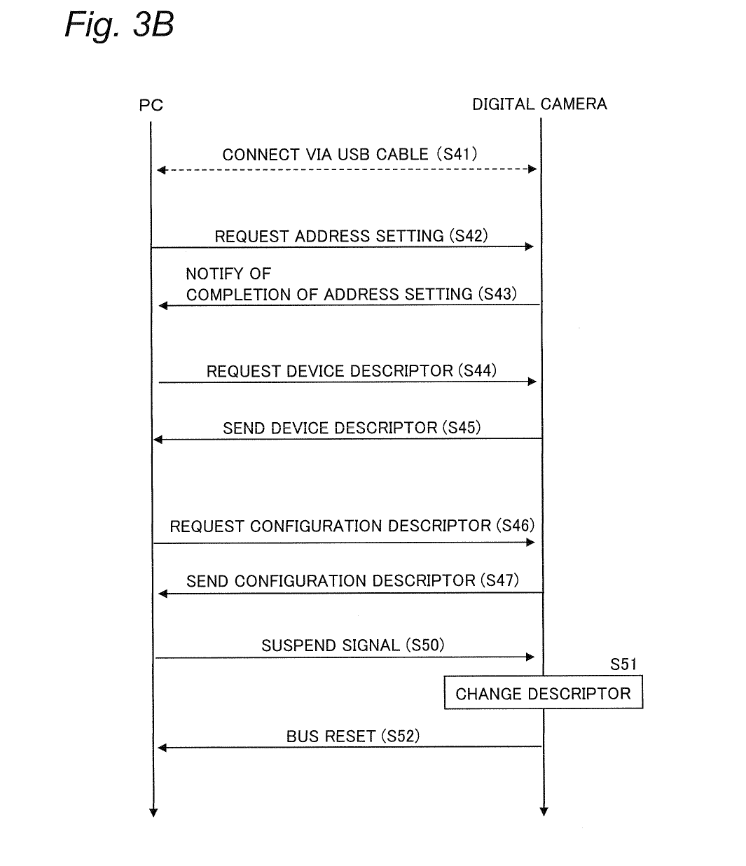

FIG. 3A is a chart showing a sequence for describing a usual operation (enumeration) for establishing communication between the digital camera 1 and the PC 10 via an USB.

Note that the PC 10 outputs a signal indicating suspension (hereinafter, referred to as “suspend signal”) to the digital camera 1 as required by the circumstance. The suspend signal is continuously output while the PC 10 is indicating suspension to the digital camera 1. Specifically, for a predetermined time immediately after the PC 10 is connected with the USB device (the digital camera 1 in the present embodiment), the PC 10 keeps outputting the suspend signal, when the PC 10 determines that the PC 10 does not support the USE device function indicated by the configuration descriptor sent from the USE device, or when the PC 10 is in the power save mode or the like.

The suspend signal which is output immediately after the USB device is connected to the PC 10 is stopped when a predetermined time elapses. Hereinafter, a suspend state indicated by the suspend signal output immediately after the connection with the USB device will be referred to as “initial suspend state”. Further, the suspend signal which is output when the PC 10 determines that PC 10 does not support the USE device function indicated by the configuration descriptor sent from the USE device is kept output until the communication between the USE device and the PC 10 is initialized (bus reset). Further, the suspend signal which is output when the PC 10 enters the power save mode or the like is stopped when the PC 10 exits the power save mode or the like.

The digital camera 1 has a function for determining in which of these occasions the suspend signal is output. The determining function will be described in detail later.

Further, since the USB connection is a system in which the host device operates as a master device, the communication goes on in the manner that the digital camera 1 responds to a request issued by the PC 10 when the digital camera 1 receives the request.

When the digital camera 1 is connected to the PC 10 via the USB cable 9, the PC 10 serving as the host device sends the suspend signal indicating the initial suspend state to the digital camera 1. The initial suspend state is disabled after a predetermined time. After the initial suspend state is disabled, the digital camera and the PC 10 start the request processing and the response processing (enumeration) to establish the communication between the digital camera 1 and the PC 10.

That is, as shown in FIG. 3A, when the digital camera 1 is connected to the PC 10 via the USB cable (S41) and subsequently the initial suspend state is disabled, the PC 10 decides the address to specify to the digital camera 1 and sends the address together with a request for the address setting to communicate with the digital camera 1 (S42).

When receiving the request for the address setting, the digital camera 1 stores the specified address and notifies the PC 10 of the completion of the address setting (S43). Setting the address specified by the PC 10 to the digital camera 1 enable the PC 10 to identify the digital camera 1 connected to the PC 10 to control. Thereby, the digital camera 1 is enabled to respond only to the request corresponding to the address specified by the PC 10.

After the address setting (S42, S43), the PC 10 requests the device descriptor from the digital camera 1 to obtain the device ID, the number of supported communication configurations and the like of the connected digital camera 1 (S44). When receiving the request for the device descriptor, the digital camera 1 sends to the PC 10 the device descriptor preset by the USB controller 7 of the digital camera 1 (S45).

Based on the obtained device descriptor, the PC 10 requests from the digital camera 1 the configuration descriptor to obtain information about the presence or absence of the power request, the communication class, and the like of the digital camera 1 (S46).

When receiving the request for the configuration descriptor, the USE controller 7 of the digital camera 1 sends to the PC 10 the configuration descriptor associated with the device descriptor preset by the descriptor switching unit 7c (S47).

Based on the obtained configuration descriptor, the PC 10 determines whether the PC 10 supports the power setting requested by the digital camera 1 (the presence or absence of request to the PC 10 for supplying power and/or the power capacity) and the communication class supported by the digital camera 1. When determining that PC 10 supports the power setting and the communication class requested by the digital camera 1, the PC 10 requests the digital camera 1 to perform the configuration setting (S48). Herein, the configuration setting request includes information for specifying the configuration to be set by the digital camera 1.

When receiving the request for the configuration setting, the USB controller 7 of the digital camera 1 performs the configuration setting to enable the digital camera 1 to communicate with the PC 10 on the communication class indicated by the configuration descriptor sent to the PC 10 (for example, the mass storage). Then, the USB controller 7 of the digital camera 1 notifies the PC 10 of the completion of the configuration setting (S49).

Henceforth, the digital camera 1 and the PC 10 can communicate with each other on the communication class set in the configuration setting.

With the above described operation, the enumeration between the digital camera 1 and the PC 10 is completed.

On the other hand, when determining that the PC 10 does not support the power setting and the communication class requested by the digital camera 1, the PC 10 does not send a request for the configuration setting to the digital camera 1. In that case, a problem occurs in that the communication between the PC 10 and the digital camera 1 never starts, as described above.

The conventional art addresses the problem by detecting the time-out. Nevertheless, that approach leaves a problem of taking much time in the communication establishment.

In contrast, the digital camera 1 according to the present embodiment solves the problem. With reference to FIG. 3B, the means to solve the problem will be outlined. Also the digital camera 1 similarly performs the typical enumeration as shown in FIG. 3A (S41 to S49). However, when the PC 10 outputs the suspend signal (S50) after the digital camera 1 sends the configuration descriptors (S47), the digital camera 1 changes the descriptors (device descriptor, configuration descriptor) to be sent to the PC 10 (S51). Then, the digital camera 1 performs the bus reset (S52) to perform the enumeration again. The suspend signal output in that time is the same as what is output in the case where the PC 10 does not support the function indicated by the configuration descriptor sent from the digital camera 1. Hence, by detecting the suspend signal in that time, the digital camera 1 can determine that the PC 10 does not support the function of the digital camera 1. As a result, the time taken for the communication establishment can be made shorter than by the approach of detecting the time-out.

The above operation of the digital camera 1 will be described in detail below.

2-2. State Transition inside Digital Camera

The state transition of the digital camera 1 according to the present embodiment during the enumeration will be described. The state manager 7a of the digital camera 1 manages the state concerning the USB connection (hereinafter, referred to as “USB connection state”) inside the digital camera 1 during the enumeration. For example, when the address setting of the digital camera 1 is completed, the state manager 7a sets the USB connection state to “address setting completed state” indicating that the address has been set. The USB connection state management can be implemented, for example, by using information indicating the USB connection state or by using a device for detecting the USB connection state.

Hereinafter, the device descriptor and the configuration descriptor will be collectively referred to as “descriptor”. Further, the configuration descriptor A and the device descriptor associated with the configuration descriptor A will be collectively referred to as “descriptor A”. The configuration descriptor B and the device descriptor associated with the configuration descriptor B will be collectively referred to as “descriptor B”.

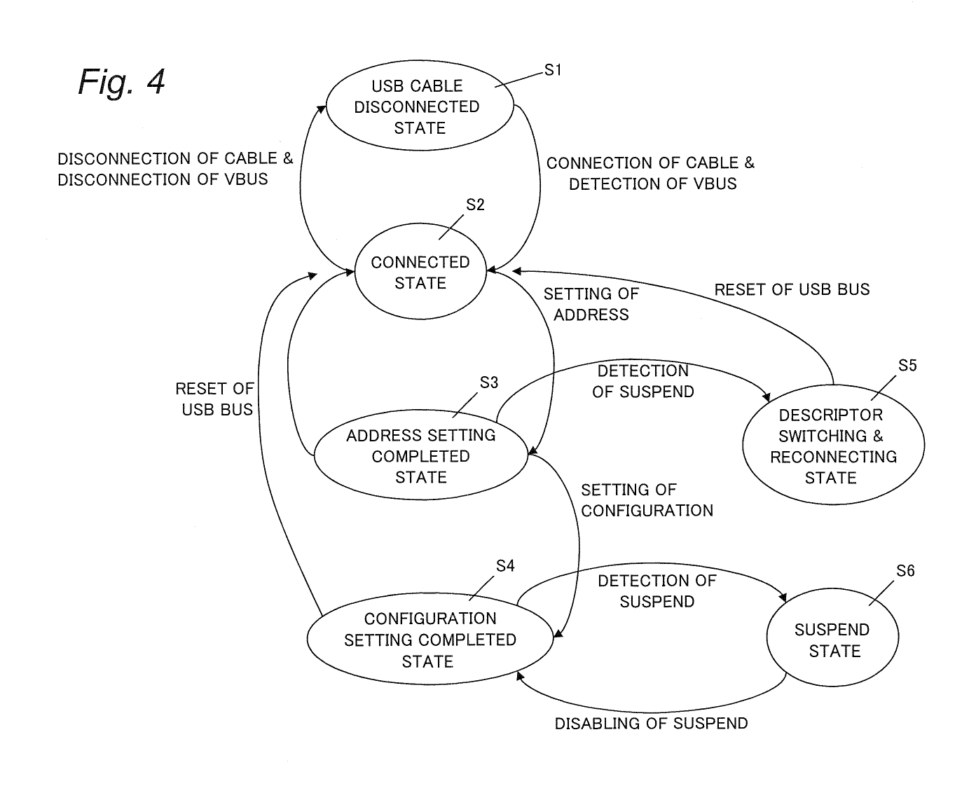

FIG. 4 is a diagram for describing transition of the USB connection state of the digital camera 1 according to the present embodiment during the enumeration.

When the power switch 15a is slid to the ON side, the state manager 7a sets the USB connection state to “USB cable disconnected state” (S1) indicating that the digital camera 1 is not connected to the PC 10 via the USB.

When the VBUS detector 7e detects connection between the digital camera 1 and the PC 10 while the USB connection state is the “USB cable disconnected state” (S1), the state manager 7a sets the USB connection state to “connected state” (S2).

When the initial suspend state is disabled and subsequently the address setting of the digital camera 1 is completed while the USB connection state is the “connected state” (S2) (steps S42, S43 in FIG. 3A), the state manager 7a sets the USB connection state to “address setting completed state” (S3).

When the request for/sending of the descriptor and the configuration setting of the digital camera 1 are completed (steps S43 to S49 in FIG. 3A) while the USB connection state is the “address setting completed state” (S3), the state manager 7a sets the USE connection state to “configuration setting completed state” (S4).

Herein, when the PC 10 does not support the power setting and the communication class indicated by the descriptor sent from the digital camera 1, as described above, the PC 10 does not request the digital camera 1 to perform the configuration setting. In that case, the PC 10 outputs the suspend signal to the digital camera 1 (step S50 in FIG. 50). Specifically, when the descriptor sent to the PC 10 includes the information requesting power and the power supply of 500 mA is requested from the PC 10, the determination on whether the PC 10 can supply the digital camera 1 with the power requested by the digital camera 1 depends on the type of the PC 10 (or the type of the OS controlling the PC 10). Therefore, when the PC 10 (or the OS controlling the PC 10) determines that PC 10 cannot supply the digital camera 1 with the power requested by the digital camera 1, the PC 10 outputs the suspend signal to the digital camera 1 without requesting the digital camera 1 to perform the configuration setting.

When the request for/sending of the descriptor is completed (steps S44 to S47 in FIG. 3A) and subsequently the suspend detector 7b detects the suspend signal while the USB connection state is the “address setting completed state” (S3), the USB controller 7 determines that the digital camera 1 cannot communicate with the PC 10 with the setting indicated by the sent descriptor. Based on the determination made by the USB controller 7, the state manager 7a sets the USB connection state to “descriptor switching and reconnecting state” (S5). In the “descriptor switching and reconnecting state” (S5), the digital camera 1 changes the descriptor from the previously sent descriptor to another descriptor (S51), and then, reconnects to the PC 10 (S52).

When the state manager 7a sets the USB connection state to the “descriptor switching and reconnecting state” (S5), the descriptor switching unit 7c changes the descriptor to be sent from the previously sent descriptor to another descriptor (S51). After that, when the bus reset start/detecting unit 7d starts the USB bus reset, the digital camera 1 and the PC 10 are connected to each other again (S52). At this time, the state manager 7a sets the USB connection state to the “connected state” (S2).

Further, when the configuration setting of the digital camera 1 is completed (steps S48 to S49 in FIG. 3A), the PC 10 communicates with the digital camera 1 on the communication class set by the digital camera 1. During the communication, the PC 10 may enter the power save mode or the like and output the suspend signal to the digital camera 1. In other words, the suspend detector 7b may detect the suspend signal when the USB connection state is the “configuration setting completed state” (S4). In that case, the state manager 7a sets the USB connection state to “suspend state” (S6). In the “suspend state” (S6), the digital camera 1 waits for the suspend state of the PC 10 due to the power save mode or the like to be disabled. When the suspend detector 7b detects that the suspend signal stops (i.e., the suspend state of the PC 10 is disabled), the state manager 7a returns the USB connection state to the “configuration setting completed state” (S4).

Further, when the bus reset start/detecting unit 7d performs (or detects) the USB bus reset while the USB connection state is the “address setting completed state” (S3) or the “configuration setting completed state” (S4), the state manager 7a sets the USE connection state to the “connected state” (S2).

Further, when the VBUS detector 7e detects that the 5V voltage supply to the VBUS stops while the USB connection state is set to any of the states shown in FIG. 4 (S1 to S6), the state manager 7a sets the USB connection state to the “USE cable disconnected state” (S1). Although FIG. 4 shows only an arrow indicating the transition from the state S2 to the state S1, the transition from any of the other states (S3 to S6) to the state S1 is also possible.

### 2-3. Detail of Operation of Digital Camera

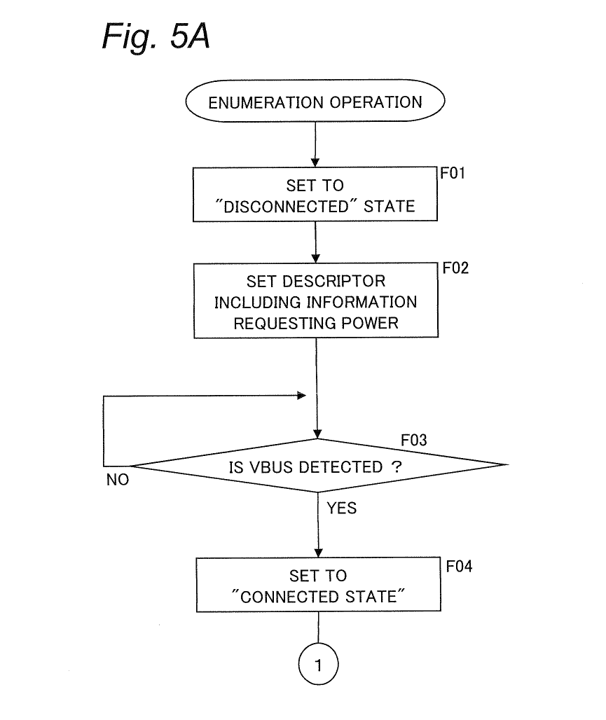

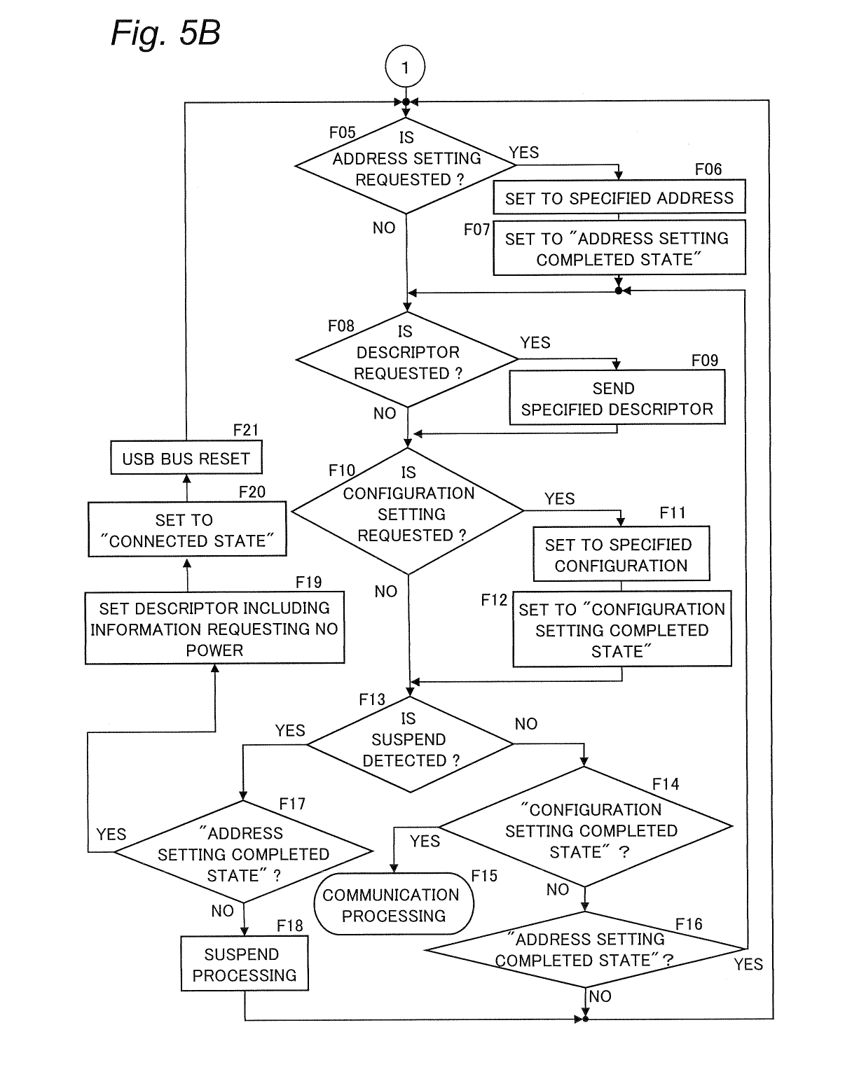

With reference to FIG. 5A and FIG. 5B, a sequence of operations of the digital camera 1 according to the present embodiment to establish connection with the PC 10 via an USB interface (enumeration) will be described in the concrete.

When the power switch 15a of the digital camera 1 is slid to the ON side, the state manager 7a sets the USB connection state to the “USB cable disconnected state” (S1) (F01). Next, the descriptor switching unit 7c sets the descriptor A as the descriptor to be sent to the PC 10 (F02). Herein, the descriptor A is the descriptor which includes the information requesting power as described above.

Then, the VBUS detector 7e detects the VBUS to determine whether the digital camera 1 and the PC 10 are connected each other via the USB cable 9 (F03). When the VBUS is not detected (NO in step F03), the VBUS detector 7e repeats the determination on the USB connection until the VBUS is detected.

On the other hand, when the VBUS detector 7e detects the VBUS (YES in step F03), the state manager 7a sets the USB connection state to the “connected state” (S2) (F04). Then, the USB controller 7 of the digital camera 1 determines whether the digital camera 1 is requested the address setting by the PC 10 (F05).

When determining that the digital camera 1 is requested the address setting (YES in step F05), the USB controller 7 sets the address of the digital camera 1 to the address specified by the PC 10 (F06). Then, the state manager 7a sets the USB connection state to the “address setting completed state” (S3) (F07).

On the other hand, when the USB controller 7 determines that the digital camera 1 is not requested the address setting (NO in step F05), or after the state manager 7a sets the USB connection state to the “address setting completed state” (S3), the USB controller 7 determines whether the digital camera 1 is requested the descriptor (the device descriptor or the configuration descriptor) by the PC 10 (F08).

When determining that the digital camera 1 is requested the descriptor (YES in step F08), the USB controller 7 sends the descriptor set in step F02 (the descriptor A in the present example) to the PC 10 (F09).

On the other hand, when the USB controller 7 determines that the digital camera 1 is not requested the descriptor (NO in step F08), or after the USB controller 7 sends the descriptor to the PC 10 (F09), the USE controller 7 determines whether the digital camera 1 is requested to perform the configuration setting by the PC 10 (F10). Herein, the configuration setting request includes information indicating the configuration specified by the PC 10.

When determining that the digital camera 1 is requested to perform the configuration setting (YES in step F10), the USB controller 7 sets the configuration of the digital camera 1 to the configuration specified by the PC 10 (F11). Then, the state manager 7a sets the USE connection state to the “configuration setting completed state” (S4) (F12).

On the other hand, when the USB controller 7 determines that the digital camera 1 is not requested to perform the configuration setting (NO in step F10), or after the state manager 7a sets the USB connection state to the “configuration setting completed state” (S4) (F12), the USB controller 7 determines whether the suspend detector 7b has detected the suspend signal (F13).

First, the case where the suspend signal is not detected (NO in step F13) will be described. When the suspend signal is not detected, the state manager 7a determines whether the current USB connection state is the “configuration setting completed state” (S4) (F14). When the configuration setting is completed (YES in step F14), since the communication has been established, the digital camera 1 communicates with the PC 10 on the set communication class (F15).

On the other hand, when the current USB connection state is not the “configuration setting completed state” (S4) (NO in step F14), the state manager 7a determines whether the USE connection state is the “address setting completed state” (S3) (F16).

When the USB connection state is not the “address setting completed state” (S3), i.e., when the address setting has not been requested by the PC 10 (NO in step F16), the USB controller 7 determines whether the address setting is requested by the PC 10 again (F05).

On the other hand, when the USB connection state is the “address setting completed state” (S3), i.e., when the address setting was already requested by the PC 10 (YES in step F16), the USB controller 7 determines whether the descriptor is requested by the PC 10 again (F08).

Through the above described operations, when the suspend signal is not detected in the determination processing for suspend signal detection (F13), the digital camera 1 can perform communication processing based on the USB connection state.

Next, the case where the suspend signal is detected in the determination processing for suspend signal detection (F13) (YES in step F13) will be described. When the suspend signal is detected in the suspend determination (F13), the USB controller 7 determines whether the current USB connection state managed by the state manager 7a is the “address setting completed state” (S3) (F17).

When the USB connection state is not the “address setting completed state” (S3) (NO in step F17), i.e., when the USB connection state is the “configuration setting completed state” (S4) or such a state in which the address has not been set (S2), the digital camera 1 determines that the PC 10 has entered the power save mode. Then, the digital camera 1 proceeds to suspend processing (F18) for waiting for the power save mode of the PC 10 to be disabled. In the operations by the other units are stopped. The USB controller 7 waits for the power save mode of the PC 10 to be disabled. That suppresses the power consumption of the digital camera 1.

On the other hand, when the USB connection state is the “address setting completed state” (S3) (YES in step F17), the digital camera 1 proceeds to processing for reconnection by using a descriptor different from the current descriptor. First in that processing, the descriptor switching unit 7c changes the descriptor to be sent to the PC 10, from the descriptor A including the information requesting power (F02) to the descriptor B including the information requesting no power (F19). Then, the state manager 7a sets the USB connection state to the “connected state” (S2) again (F20). Further, the bus reset start/detecting unit 7d starts the USB bus reset (F21). As a result of the processing, in response to the USB bus reset, the PC 10 restarts the communication with the digital camera 1 from the address setting.

In the above manner, when the suspend signal is detected while the USB connection state is the “address setting completed state” (S3), the digital camera 1 determines that the detected suspend signal is output when the PC 10 does not support the function indicated by the descriptor sent from the digital camera 1. At this time, the digital camera 1 can immediately switch the descriptor and reconnect to the PC 10.

As described above, during the communication connection between the PC 10 and the digital camera 1, the digital camera 1 responds to a descriptor request issued by the PC 10 by sending the descriptor. When the PC 10 suspends the operation by the reason that PC 10 cannot communicate with the digital camera 1 according to the contents of the descriptor sent in the descriptor response from the digital camera 1, the digital camera 1 can immediately switch the descriptor and connect with the PC 10 again without waiting for a request for configuration setting issued by the PC 10. Therefore, the digital camera 1 according to the present embodiment can provide an excellent effect that the digital camera 1 can address the suspended state without waiting for the time out.

Note that the RAM/ROM 14 according to the present embodiment stores the descriptor A including the “information requesting power” and the descriptor B including the “information requesting no power”. However, the RAM/ROM 14 may store a descriptor indicating another function.

### 3. Summary of Present Embodiment

As described above, the digital camera 1 according to the present embodiment is capable of operating as an USB function with being connected to the PC via an USB interface. The digital camera 1 includes a RAM/ROM 14 configured to storing a descriptor which is information indicating a function of the digital camera 1, an USB connector 8 configured to sending the descriptor to the PC 10, a suspend detector 7b configured to detecting a suspend signal that is output from the PC 10 and indicates suspension, and an USB controller 7 configured to performing predetermined processing based on the detection result, when the suspend detector 7b detects the suspend signal after the USB connector 8 sends the descriptor to the PC 10, in the enumeration between the digital camera 1 and the PC 10.

The digital camera 1 with the above described configuration performs predetermined processing based on the detection result, when the suspend detector 7b detects a suspend signal after the digital camera 1 sends a descriptor to the PC 10 via the USE connector 8. Thereby, when connected to the PC 10, the digital camera 1 can perform the enumeration-related processing faster than an electronic apparatus that detects the time out.

Further, In the digital camera 1 according to the present embodiment, the RAM/ROM 14 stores two descriptors which respectively indicate different functions. As predetermined processing, the USB controller 7 changes a descriptor to be sent to the PC 10, from the sent descriptor to another descriptor, and then initializes the communication between the digital camera 1 and the PC 10.

In the enumeration between the PC 10 and the digital camera 1 in which the PC 10 sends the suspend signal to the digital camera 1 when the PC 10 does not support the function of the digital camera 1, when the suspend detector 7b detects the suspend signal after the USE connector 8 sends the descriptor to the PC 10 based on the detection result, the digital camera 1 with the above described configuration switches the descriptor and then starts the USB bus reset. Thereby, the digital camera 1 can perform the enumeration again by using the changed another descriptor faster than an electronic apparatus that detects the time out, without diminishing the possibilities of establishing the communication with the PC 10.

### 4. Other Embodiments

The idea of the above described embodiment is not limited to the embodiment described above. Various embodiments may also be considered. Other embodiments to which the idea of the above described embodiment can be applied will be described below.

Although the digital camera 1 according to the above described embodiment stores two descriptors, the digital camera 1 may store three or more descriptors. In that case, the USB controller 7 may repeat instructing the USB controller 7 to send another one of the plurality of descriptors to the PC 10 in enumeration until the suspend detector 7b does not detect the suspend signal output from the PC 10 and connection is established between the digital camera 1 and the PC 10.

Further, in the digital camera 1 according to the above described embodiment, one configuration descriptor is associated with one device descriptor. However, a plurality of configuration descriptors may be associated with one device descriptor.

Further, in the above described embodiment, the digital camera is described as an example of the electronic apparatus. However, the electronic apparatus is not limited to a digital camera and may be arbitrary apparatus that is configured to an USB connection as a function. The idea of the above described embodiment can also be applied to the electronic apparatus having substantially the same control unit as the USB controller 7 according to the above described embodiment (for example, a video camera, a cell phone, a smart phone, a handheld game player, or the like) or the like.

Further, in the above described embodiment, an USE apparatus (digital camera) that connects to a PC via an USB interface is exemplified. However, the idea of the above described embodiment is not limited to that. The idea of the embodiment can also be applied to an electronic apparatus that connects to a host device via an interface other than an USE. Yet, the electronic apparatus sends information indicating a function of the electronic apparatus (function information) to the host device to establish communication with the host device. Further, when the host device does not support the function indicated by the sent function information, the host device sends a predetermined signal to the electronic apparatus.

Further, in the above described embodiment, when the PC 10 does not support the function indicated by the descriptor sent from the digital camera 1, the digital camera 1 changes the descriptor to reconnect to the PC 10. However, the idea of the above described embodiment is not limited to that. When the PC 10 does not support the function indicated by the descriptor sent from the digital camera 1, the digital camera 1 may terminate the communication with the PC 10. Thereby, even when the communication between the digital camera 1 and the PC 10 cannot be established as a result, the digital camera 1 can complete the enumeration faster than the case where the time out is detected.

The embodiments have been described above as examples of the art of the present disclosure. For this purpose, the detailed description and the attached drawings have been disclosed. Therefore, some of the elements described in the detailed description and shown in the attached drawings may be unnecessary to solve the problem. Therefore, the unnecessary element should not be instantly recognized as a necessary element merely because being described in the detailed description and shown in the attached drawings.

In the above described embodiment, if the PC 10 does not support the function indicated by the descriptor sent from the digital camera 1, the digital camera 1 changes the descriptor and reconnect to the PC 10. However, the idea of the above described embodiment is not limited to that. If the PC 10 does not support the function indicated by the descriptor sent from the digital camera 1, the digital camera 1 may terminate the communication with the PC 10. Accordingly, even in the case where the communication between the digital camera 1 and the PC 10 cannot be established as a result, the digital camera 1 can complete the enumeration faster than the case where the time out is detected.

### INDUSTRIAL APPLICABILITY

The technology of the present disclosure can be applied to an electronic apparatus or the like capable of connecting to a host device that sends a predetermined signal to the electronic apparatus when the host device does not support the functions of the electronic apparatus, wherein the electronic apparatus (a digital camera, a video camera, a cell phone, a smart phone, a handheld game player, or the like) or the like establishes the communication with the host device by sending information indicating functions of the electronic apparatus (descriptor or the like) to the host device.

What is claimed is:

1. An electronic apparatus capable of operating as a USE function when connected to a host device via an USB interface, comprising:
a storing unit configured to store a descriptor which is information indicating a function of the electronic apparatus;
a sending unit configured to send the descriptor to the host device;
a detector configured to detect a suspend signal that is output from the host device and indicates suspension; and
a controller configured to perform predetermined processing based on the detection result, when the detector detects the suspend signal after the sending unit sends the descriptor to the host device, in enumeration between the electronic apparatus and the host device.

2. The electronic apparatus according to claim 1, wherein:
the storing unit stores two types of descriptors each indicating a function different from each other; and
when the detector detects the suspend signal after the sending unit sends one of the two types of descriptors to the host device, the controller performs as the predetermined processing:
changing of a descriptor to be sent to the host device, from the one of the descriptors to the other of the descriptors, and
initializing of communication between the electronic apparatus and the host device.

3. The electronic apparatus according to claim 1, further comprising a state manager configured to manage a connection state between the electronic apparatus and the host device, wherein:
in the enumeration, when the detector detects the suspend signal after the sending unit sends the descriptor to the host device, the controller performs the predetermined processing based on the detection result and the connection state.

4. The electronic apparatus according to claim 1, wherein:
the controller terminates the communication between the electronic apparatus and the host device, as the predetermined processing.

5. An electronic apparatus capable of connecting to a host device that sends a predetermined signal to the electronic apparatus when the host device does not support a function of the electronic apparatus, the electronic apparatus comprising:
a storing unit configured to store function information which is information indicating a function of the electronic apparatus;
a sending unit configured to send the function information to the host device;
a detector configured to detect the predetermined signal; and
a controller configured to perform predetermined processing based on the detection result, when the detector detects the predetermined signal after the function information is sent to the host device, in processing for establishing communication between the electronic apparatus and the host device.

6. An electronic apparatus capable of operating as a USB device when connected to a host device via an USE interface, said electronic apparatus comprising:
a storing unit configured to store a plurality of descriptors indicating a plurality of functions, respectively;
a sending unit configured to send a first descriptor among the plurality of the descriptors to the host device;
a detector configured to detect a suspend signal output from the host device; and
a controller configured to instruct the sending unit to send another one of the plurality of descriptors to the host device when the detector detects the suspend signal after the sending unit sends the first descriptor to the host device.

7. The electronic apparatus according to claim 6, wherein the controller repeats instructing the controller to send another one of the plurality of descriptors to the host device in enumeration until the detector does not detect the suspend signal output from the host device and connection is established between the electronic apparatus and the host device.
